(19) United States
(12) Patent Application Publication
(10) Pub. No.: US 2026/0268276 A1
(43) Pub. Date: Sep. 10, 2026

(54) SYSTEM, METHOD, AND SMART STORAGE DEVICE FOR STORAGE AND MANAGEMENT OF ITEMS

(71) Applicants: Bhavana Dipak SANGHAVI, Mumbai, Maharashtra (IN); Ateet Dipak SANGHAVI, Mumbai, Maharashtra (IN)

(72) Inventor: Ateet Dipak SANGHAVI, Mumbai, Maharashtra (IN)

(21) Appl. No.: 18/875,487

(22) PCT Filed: May 8, 2023
(86) PCT No.: PCT/IB2023/054746

§ 371 Date: Dec. 16, 2024

(30) Foreign Application Priority Data
Jun. 16, 2022 (IN) 202221034425

(51) Int. Cl. G06Q 10/087

(52) U.S. Cl. CPC G06Q 10/08776

(57) ABSTRACT

A smart storage device (100) includes a base (102) including a first sensor (110) and a transceiver unit (112) configured to receive and send data; a storage compartment (104) configured to store an item (106); a lid (108) removably coupled to the container and configured to selectively allow access to the container when the lid is in an open configuration, the lid including a second sensor. The smart storage device further includes a computing device (200) configured to receive, from the first sensor, first signals indicative of a weight of the item; receive, from the second sensor, second signals indicative of a state of the item. The controller is configured to extract one or more parameters relating to the item based on analysis of the first and second signals.

### TECHNICAL FIELD

The present disclosure generally relates to a storage device for storage and management of items.

### BACKGROUND

Background description includes information that may be useful in understanding the present invention. It is not an admission that any of the information provided herein is prior art or relevant to the presently claimed invention, or that any publication specifically or implicitly referenced is prior art.

Storage of perishable or consumable items can be a challenge, in terms of gauging how much quantity is remaining or what state the remaining item is in. Conventionally, a visual inspection is required. However, in case where there are innumerable items, visual, or manual inspection is very cumbersome.

There is therefore a requirement in the art for a means to easily monitor a quantity or state of an item in a storage device.

### OBJECTS OF THE INVENTION

An object of the present invention is to provide a smart storage device, a system, and a method for storage and management of items.

Another object of the present invention is to provide a system that can generate an alert when the item stored therein begins to spoil.

Another object of the present invention is to provide a system that can generate an alert when the item stored therein is to be replenished.

Another object of the present invention is to provide a system that can assist in shopping for items based on a recipe to be followed.

Another object of the present invention is to provide a system that can assist in following of a recipe in multiple languages.

Another object of the present invention is to provide a smart storage device with an easily readable label in multiple languages.

### SUMMARY

In a first aspect, the present disclosure provides a system for storage and management of items. The system includes a smart storage device including a base including one or more first sensors configured to measure at least one of a weight, a quantity, a temperature, and an identity of items stored in the smart storage device. The smart storage device further includes a storage compartment configured to store the items. The system further includes a computing device communicably coupled to the smart storage device. The computing device includes a processor communicably coupled to a memory, the memory storing instructions, which when executed by the processor causes the computing device to be configured to receive, from the one or more first sensors, first signals indicative of at least one of the weight, quantity, temperature, and identity of the items stored in the smart storage device. The computing device is further configured to determine the at least one of the weight, the quantity, the temperature, and the identity of the items stored in the smart storage device, based on analysis of the first signals. The computing device is further configured to display the determined at least one of weight, quantity, temperature, and identity of the items stored in the smart storage device on a display device provided on the smart storage device, and communicably coupled to the computing device. The display device is configured to display the determined at least one of weight, quantity, temperature, and identity of the items stored in the smart storage device in any one or more languages as selected by a user of the smart storage device. The computing device is further configured to transmit the determined at least one of weight, quantity, temperature, and identity of the items stored in the smart storage device to a central database communicably coupled to the computing device.

In some embodiments, the smart storage device further includes a lid removably coupled to the storage compartment, and configured to selectively allow access to the storage compartment. The lid includes one or more second sensors communicably coupled to the computing device, and configured to measure at least a state of the items stored in the smart storage device. The computing device is further configured to receive, from the one or more second sensors, second signals indicative of at least the state of the items stored in the smart storage device. The computing device is further configured to determine the at least the state of the items stored in the smart storage device based on analysis of the second signals The computing device is further configured to display the determined at least state of the items stored in the smart storage device on the display device. The computing device is further configured to transmit the determined at least state of the items stored in the smart storage device to the central database.

In some embodiments, the lid further includes an optical device communicably coupled to the computing device and configured to capture an optical image of the item stored in the smart storage device. The computing device is further configured to receive, from the optical device, the captured optical image of the items stored in the smart storage device. The computing device is further configured to determine the state of the item stored in the container of the smart storage device further based on analysis of the captured optical image of the items stored in the smart storage device.

In some embodiments, the lid further includes a valve operable to allow evacuation of air from within the storage compartment of the smart storage device.

In some embodiments, the one or more first sensors include at least one of a weight sensor, a temperature sensor, an RFID sensor, a QR code reader, and a barcode reader, and wherein the one or more second sensors include at least one of a smell sensor, and an optical sensor.

In some embodiments, the smart storage device further includes a power source configured to supply power to components of the smart storage device.

In some embodiments, the computing device is further configured to receive a mode of operation. The computing device is further configured to extract, from the central database, at least one of the identity, weight, quantity, temperature, and state of the items stored the smart storage device. The computing device is further configured to determine one or more parameters relating to at least one of the identity, weight, quantity, temperature, and state of the items stored in the smart storage device based on the received mode of operation. The computing device is further configured to generate a notification relating to the determined one or more parameters. The computing device is further configured to transmit the generated notification to the central database.

In some embodiments, the mode of operation includes a shopping mode, and a recipe mode.

In some embodiments, in shopping mode, the computing device is further configured to determine a first parameter relating to the weight of the items stored in the smart storage device. The computing device is further configured to determine a second parameter relating to the state of the items stored in the smart storage device. When at least one of the weight of the items is less than a predefined threshold, and the state of the items lies outside a normal range, the computing device is configured to generate a notification indicating that the items are to be replenished. The computing device is further configured to transmit the generated notification to the central database.

In some embodiments, the computing device is further configured to receive a recipe. The computing device is further configured to determine, based on the recipe, at least one of a required weight and a required quantity of the items required for the recipe. When at least one of the weight and quantity of the items is less than the corresponding determined required weight and the required quantity of the items, the computing device is configured to generate a notification indicating that the items are to be replenished. The computing device is further configured to transmit the generated notification to the central database.

In some embodiments, in recipe mode, the computing device is further configured to receive a recipe. The computing device is further configured to determine a chronology for the items to be used, based on the recipe. The computing device is further configured to generate a notification indicating an instant of access of the smart storage device based on the determined chronology for the items to be used. The computing device is further configured to transmit the generated notification to the central database.

In some embodiments, the system further includes a voice-enabled device, and wherein the voice-enabled device is configured to present the notification indicating an instant of access of the smart storage device in any one or more languages as selected by a user of the smart storage device.

In some embodiments, the voice enabled device is configured to emit a sound to indicate the instant of access of the smart storage device.

In some embodiments, the system includes a microphone communicably coupled to the computing device, wherein the computing device is configured to receive the mode of operation as a vocal command.

In a second aspect, the present disclosure provides a method for storage and management of items. The method includes receiving, at a computing device, from one or more first sensors of a smart storage device, first signals indicative of at least one of the weight, quantity, temperature, and identity of the items stored in the smart storage device. The smart storage device includes a base including the one or more first sensors configured to measure at least one of a weight, a quantity, a temperature, and an identity of items stored in the smart storage device. The smart storage device further includes a storage compartment configured to store the items. The method further includes determining, at the computing device, the at least one of the weight, the quantity, the temperature, and the identity of the items stored in the smart storage device, based on analysis of the first signals. The method further includes displaying, by the computing device, at a display device provided on the smart storage device, and communicably coupled to the computing device, the determined at least one of weight, quantity, temperature, and identity of the items stored in the smart storage device. The display device is configured to display the determined at least one of weight, quantity, temperature, and identity of the items stored in the smart storage device in any one or more languages as selected by a user of the smart storage device. The method further includes transmitting, by the computing device, the determined at least one of weight, quantity, temperature, and identity of the items stored in the smart storage device to a central database communicably coupled to the computing device.

In a third aspect, the present disclosure provides a smart storage device for storage and management of items. The smart storage device includes a base including one or more first sensors configured to measure at least one of a weight, a quantity, a temperature, and an identity of items stored in the smart storage device. The smart storage device further includes a storage compartment configured to store the items. The smart storage device further includes a computing device including a processor communicably coupled to a memory, the memory storing instructions, which when executed by the processor causes the computing device to be configured to receive, from the one or more first sensors, first signals indicative of at least one of the weight, quantity, temperature, and identity of the items stored in the smart storage device. The computing device is further configured to determine the at least one of the weight, the quantity, the temperature, and the identity of the items stored in the smart storage device, based on analysis of the first signals. The computing device is further configured to display the determined at least one of weight, quantity, temperature, and identity of the items stored in the smart storage device on a display device provided on the smart storage device, and communicably coupled to the computing device. The display device is configured to display the determined at least one of weight, quantity, temperature, and identity of the items stored in the smart storage device in any one or more languages as selected by a user of the smart storage device. The computing device is configured to transmit the determined at least one of weight, quantity, temperature, and identity of the items stored in the smart storage device to a central database communicably coupled to the computing device.

Various objects, features, aspects, and advantages of the inventive subject matter will become more apparent from the following detailed description of preferred embodiments, along with the accompanying drawing figures in which like numerals represent like components.

### BRIEF DESCRIPTION OF DRAWINGS

The accompanying drawings are included to provide a further understanding of the present disclosure and are incorporated in and constitute a part of this specification. The drawings illustrate exemplary embodiments of the present disclosure and, together with the description, serve to explain the principles of the present disclosure.

FIG. 1 illustrates a schematic block diagram of a system for storage and management of items, according to an embodiment of the present disclosure;

FIG. 2A illustrates a schematic block diagram of a base of a smart storage device, according to an embodiment of the present disclosure;

FIG. 2B illustrates a schematic block diagram of a lid of the smart storage device, according to an embodiment of the present disclosure;

FIG. 3 illustrates a schematic block diagram of a computing device of the system of FIG. 1, according to an embodiment of the present disclosure;

FIG. 4 illustrates a flow chart of a method for storage and management of items, according to an embodiment of the present disclosure; and

FIG. 5 illustrates an exemplary schematic block diagram of a hardware platform for implementation of the system of FIG. 1.

### DETAILED DESCRIPTION

The following is a detailed description of embodiments of the disclosure depicted in the accompanying drawings. The embodiments are in such details as to clearly communicate the disclosure. However, the amount of detail offered is not intended to limit the anticipated variations of embodiments; on the contrary, the intention is to cover all modifications, equivalents, and alternatives falling within the spirit and scope of the present disclosure as defined by the appended claims.

In a first aspect, the present disclosure provides a system for storage and management of items. The system includes a smart storage device including a base including one or more first sensors configured to measure at least one of a weight, a quantity, a temperature, and an identity of items stored in the smart storage device. The smart storage device further includes a storage compartment configured to store the items. The system further includes a computing device communicably coupled to the smart storage device. The computing device includes a processor communicably coupled to a memory, the memory storing instructions, which when executed by the processor causes the computing device to be configured to receive, from the one or more first sensors, first signals indicative of at least one of the weight, quantity, temperature, and identity of the items stored in the smart storage device. The computing device is further configured to determine the at least one of the weight, the quantity, the temperature, and the identity of the items stored in the smart storage device, based on analysis of the first signals. The computing device is further configured to display the determined at least one of weight, quantity, temperature, and identity of the items stored in the smart storage device on a display device provided on the smart storage device, and communicably coupled to the computing device. The display device is configured to display the determined at least one of weight, quantity, temperature, and identity of the items stored in the smart storage device in any one or more languages as selected by a user of the smart storage device. The computing device is further configured to transmit the determined at least one of weight, quantity, temperature, and identity of the items stored in the smart storage device to a central database communicably coupled to the computing device.

In some embodiments, the smart storage device further includes a lid removably coupled to the storage compartment, and configured to selectively allow access to the storage compartment. The lid includes one or more second sensors communicably coupled to the computing device, and configured to measure at least a state of the items stored in the smart storage device. The computing device is further configured to receive, from the one or more second sensors, second signals indicative of at least the state of the items stored in the smart storage device. The computing device is further configured to determine the at least the state of the items stored in the smart storage device based on analysis of the second signals The computing device is further configured to display the determined at least state of the items stored in the smart storage device on the display device. The computing device is further configured to transmit the determined at least state of the items stored in the smart storage device to the central database.

In some embodiments, the lid further includes an optical device communicably coupled to the computing device and configured to capture an optical image of the item stored in the smart storage device. The computing device is further configured to receive, from the optical device, the captured optical image of the items stored in the smart storage device. The computing device is further configured to determine the state of the item stored in the container of the smart storage device further based on analysis of the captured optical image of the items stored in the smart storage device.

In some embodiments, the lid further includes a valve operable to allow evacuation of air from within the storage compartment of the smart storage device.

In some embodiments, the one or more first sensors include at least one of a weight sensor, a temperature sensor, an RFID sensor, a QR code reader, and a barcode reader, and wherein the one or more second sensors include at least one of a smell sensor, and an optical sensor.

In some embodiments, the smart storage device further includes a power source configured to supply power to components of the smart storage device.

In some embodiments, the computing device is further configured to receive, from the user, a mode of operation. The computing device is further configured to extract, from the central database, at least one of the identity, weight, quantity, temperature, and state of the items stored the smart storage device. The computing device is further configured to determine one or more parameters relating to at least one of the identity, weight, quantity, temperature, and state of the items stored in the smart storage device based on the received mode of operation. The computing device is further configured to generate a notification relating to the determined one or more parameters. The computing device is further configured to transmit the generated notification to the central database.

In some embodiments, the mode of operation includes a shopping mode, and a recipe mode.

In some embodiments, in shopping mode, the computing device is further configured to determine a first parameter relating to the weight of the items stored in the smart storage device. The computing device is further configured to determine a second parameter relating to the state of the items stored in the smart storage device. When at least one of the weight of the items is less than a predefined threshold, and the state of the items lies outside a normal range, the computing device is configured to generate a notification indicating that the items are to be replenished. The computing device is further configured to transmit the generated notification to the central database.

In some embodiments, the computing device is further configured to receive a recipe. The computing device is further configured to determine, based on the recipe, at least one of a required weight and a required quantity of the items required for the recipe. When at least one of the weight and quantity of the items is less than the corresponding determined required weight and the required quantity of the items, the computing device is configured to generate a notification indicating that the items are to be replenished. The computing device is further configured to transmit the generated notification to the central database.

In some embodiments, in recipe mode, the computing device is further configured to receive a recipe. The computing device is further configured to determine a chronology for the items to be used, based on the recipe. The computing device is further configured to generate a notification indicating an instant of access of the smart storage device based on the determined chronology for the items to be used. The computing device is further configured to transmit the generated notification to the central database.

In some embodiments, the system further includes a voice-enabled device, and wherein the voice-enabled device is configured to present the notification indicating an instant of access of the smart storage device in any one or more languages as selected by a user of the smart storage device.

In some embodiments, the voice enabled device is configured to emit a sound to indicate the instant of access of the smart storage device.

In some embodiments, the system includes a microphone communicably coupled to the computing device, wherein the computing device is configured to receive the mode of operation as a vocal command.

In a second aspect, the present disclosure provides a method for storage and management of items. The method includes receiving, at a computing device, from one or more first sensors of a smart storage device, first signals indicative of at least one of the weight, quantity, temperature, and identity of the items stored in the smart storage device. The smart storage device includes a base including the one or more first sensors configured to measure at least one of a weight, a quantity, a temperature, and an identity of items stored in the smart storage device. The smart storage device further includes a storage compartment configured to store the items. The method further includes determining, at the computing device, the at least one of the weight, the quantity, the temperature, and the identity of the items stored in the smart storage device, based on analysis of the first signals. The method further includes displaying, by the computing device, at a display device provided on the smart storage device, and communicably coupled to the computing device, the determined at least one of weight, quantity, temperature, and identity of the items stored in the smart storage device. The display device is configured to display the determined at least one of weight, quantity, temperature, and identity of the items stored in the smart storage device in any one or more languages as selected by a user of the smart storage device. The method further includes transmitting, by the computing device, the determined at least one of weight, quantity, temperature, and identity of the items stored in the smart storage device to a central database communicably coupled to the computing device.

In a third aspect, the present disclosure provides a smart storage device for storage and management of items. The smart storage device includes a base including one or more first sensors configured to measure at least one of a weight, a quantity, a temperature, and an identity of items stored in the smart storage device. The smart storage device further includes a storage compartment configured to store the items. The smart storage device further includes a computing device including a processor communicably coupled to a memory, the memory storing instructions, which when executed by the processor causes the computing device to be configured to receive, from the one or more first sensors, first signals indicative of at least one of the weight, quantity, temperature, and identity of the items stored in the smart storage device. The computing device is further configured to determine the at least one of the weight, the quantity, the temperature, and the identity of the items stored in the smart storage device, based on analysis of the first signals. The computing device is further configured to display the determined at least one of weight, quantity, temperature, and identity of the items stored in the smart storage device on a display device provided on the smart storage device, and communicably coupled to the computing device. The display device is configured to display the determined at least one of weight, quantity, temperature, and identity of the items stored in the smart storage device in any one or more languages as selected by a user of the smart storage device. The computing device is configured to transmit the determined at least one of weight, quantity, temperature, and identity of the items stored in the smart storage device to a central database communicably coupled to the computing device.

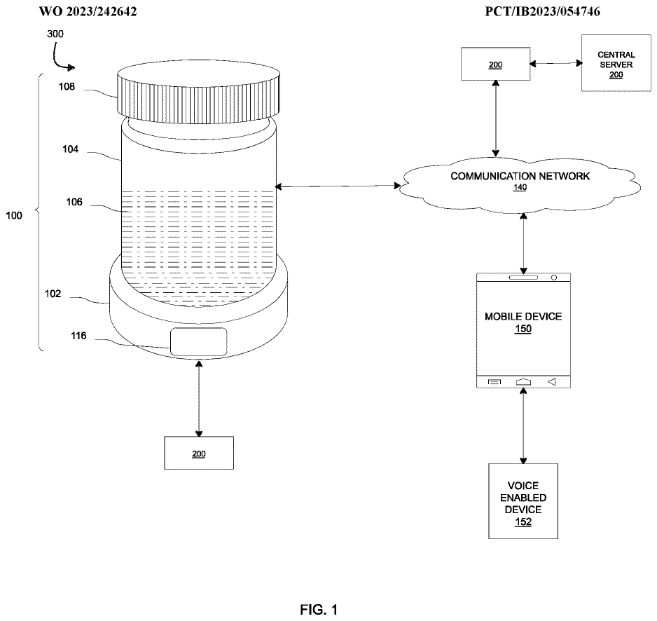

FIG. 1 illustrates a schematic block diagram of a system 300 for storage and management of items, according to an embodiment of the present disclosure. The system 300 includes a start storage device 100. The smart storage device 100 may be interchangeably referred to as “the device 100”. The device 100 may be communicably coupled to a mobile device 150 via a communication network 140. The mobile device 150 may be any electrical, electronic, electromechanical, and computing device associated with a user of the device 100. The electronic device 108 may include, without limitations, a mobile device, a smart phone, a Personal Digital Assistant (PDA), a tablet computer, a phablet computer, a wearable device, a Virtual Reality/Augment Reality (VR/AR) device, a laptop, a desktop, and the like. The communication network 140 may be a wired communication network or a wireless communication network. The wireless communication network may be any wireless communication network capable to transfer data between entities of that network such as, but are not limited to, a carrier network including circuit switched network, a public switched network, a Content Delivery Network (CDN) network, a Long-Term Evolution (LTE) network, a Global System for Mobile Communications (GSM) network and a Universal Mobile Telecommunications System (UMTS) network, an Internet, intranets, local area networks, wide area networks, mobile communication networks, combinations thereof, and the like.

In some embodiments, the device 100 is used for storage of perishable items, such as food items. The device 100 includes a base 102, a storage compartment 104 configured to store an item 106 and a lid 108. The lid 108 is removably coupled to the storage compartment 104 and is configured to selectively allow access to the storage compartment 104 when the lid 108 is in an open configuration.

In some embodiments, the system 300 may include a central database 250. The central database 250 may be communicably coupled to the device 100 via a communication network 140. The central database 250 may implement the system 300 for storage and management of items, and any computations or analyses may be performed on the central database 250.

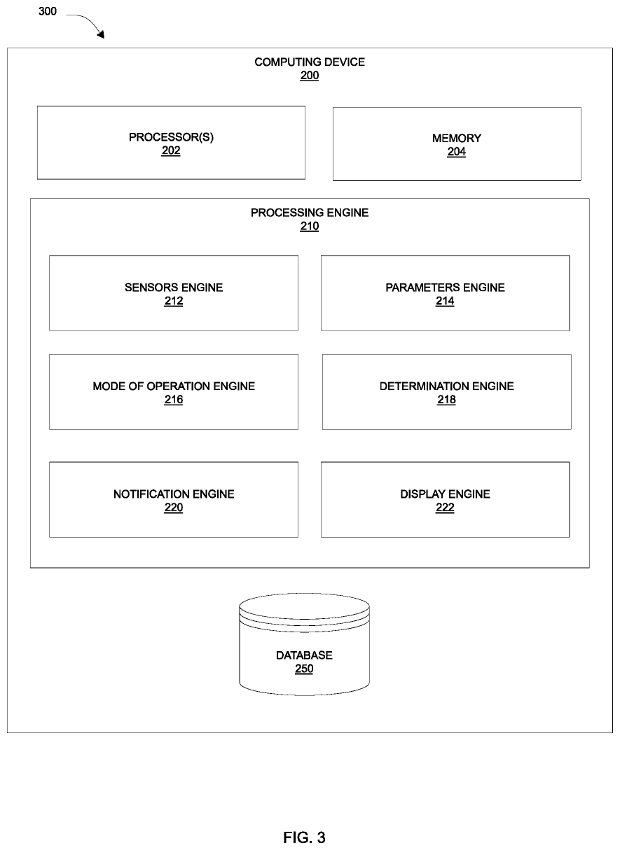

In some embodiments, the device 100 further includes a computing device 200. The computing device 200 may implement the system 300for storage and management of items. The system 300 may be implemented by means of a computing device 200 (shown in FIG. 3).

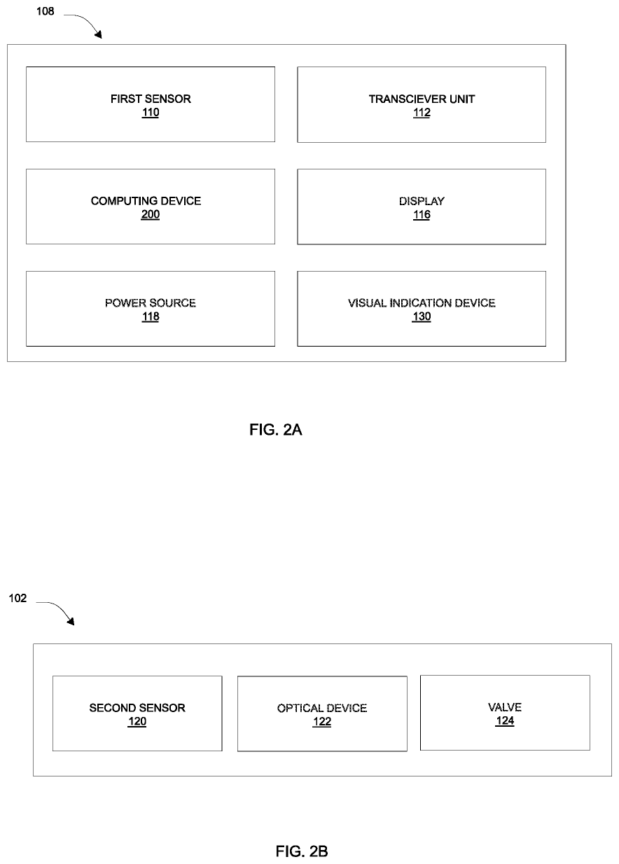

FIG. 2A illustrates a schematic block diagram of the base 102 of the device 100, according to an embodiment of the present disclosure. Referring now to FIGS. 1 and 2A, the base 102 includes one or more first sensors 110. The base 102 may further include a transceiver unit 112 configured to receive and send data. The transceiver unit 112 is configured to receive and send data via the communication network 140. In some embodiments, the first sensor 110 is a weight sensor. In some embodiments, the base 102 further includes a display 116 communicably coupled to the computing device 200. The display 116 is configured to display a name of the item 106 stored in the storage compartment 104 of the device 100. The name may be provided by the user via the mobile device 150. In some embodiments, the display 116 may be configured to display the name of the item 106 in a plurality of languages. In some embodiments, a lexicon for the plurality of languages may be stored in the central database 250. In some other embodiments, the name may be a combination of textual and pictorial.

FIG. 2B illustrates a schematic block diagram of the lid 108 of the device 100, according to an embodiment of the present disclosure. Referring to FIGS. 1 and 2B, the lid 108 includes one or more second sensors 120. In some embodiments, the second sensor 120 is a smell sensor. In some embodiments, the lid 108 further includes an optical device 122 communicably coupled to the computing device 200 and configured to capture an optical image of the item 106 stored in the storage compartment 104 of the device 100. The optical device 122 may be operated by the user by instruction via the mobile device 150. In another embodiment, the lid 108 further includes a valve 124 operable to allow evacuation of air from within the storage compartment 104 of the device 100. The valve 124 may be connected to an evacuation pump, and may be operable by the user through instruction provided via the mobile device 150.

In some embodiments, the device 100 further includes a power source 118 configured to supply power to components of the device 100.

FIG. 3 illustrates a schematic block diagram of the computing device 200 of the device 100, according to an embodiment of the present disclosure. Referring now to FIGS. 1-3, the computing device 200 is communicably coupled to the one or more first sensors 110, the transceiver unit 112, and the one or more second sensors 120. The computing device 200 includes a processor 202 communicably coupled to a memory 204. The memory 204 stores instructions executable by the processor 202.

In some embodiments, the processor 202 may be implemented as one or more microprocessors, microcomputers, microcontrollers, digital signal processors, central processing units, logic circuitries, and/or any devices that process data based on operational instructions. Among other capabilities, the processor 202 may be configured to fetch and execute computer-readable instructions stored in the memory 204 for facilitating the system 300 for storage and management of items 106. Any reference to a task in the present disclosure may refer to an operation being or that may be performed on data. The memory 204 may be configured to store one or more computer-readable instructions or routines in a non-transitory computer readable storage medium for monitoring the item 106 in the device 100. The memory 204 may include any non-transitory storage device including, for example, volatile memory such as RAM, or non-volatile memory such as EPROM, flash memory, and the like.

In some embodiments, the computing device 200 includes a processing engine 210. The processing engine 210 may be implemented as a combination of hardware and programming (for example, programmable instructions) to implement one or more functionalities of the processing engine 210. In examples described herein, such combinations of hardware and programming may be implemented in several different ways. For example, the programming for the processing engine 210 may be processor executable instructions stored on a non-transitory machine-readable storage medium and the hardware for the processing engine 210 may include a processing resource (for example, one or more processors), to execute such instructions. In the present examples, the machine-readable storage medium may store instructions that, when executed by the processing resource, implement the processing engine 210. In such examples, the computing device 200 may include the machine-readable storage medium storing the instructions and the processing resource to execute the instructions, or the machine-readable storage medium may be separate but accessible to the computing device 200 and the processing resource. In other examples, the processing engine 210 may be implemented by electronic circuitry.

The processing engine 210 includes a sensors engine 212, a parameters engine 214, a mode of operation engine 216, a determination engine 218, a notification engine 220, and a display engine 222. The sensor engine 212 is configured to receive, from the one or more first sensor 110, first signals indicative of at least one of weight, quantity, temperature, and identity of the item 106 stored in the device 100. The sensor engine 212 is further configured to receive, from the one or more second sensors 120, second signals indicative of a state of the item 106 stored in the device 100. The parameters engine 214 is configured to determine the at least one of weight, quantity, temperature, identity, and state of the item 106 stored in the device 100, based on analysis of the first and second signals, respectively. The processing engine 210 is further configured to transmit the determined weight, quantity, temperature, and identity, and state of the item 106 stored in the device 100 to the central database 250 communicably coupled to the computing device 200.

In some embodiments, the processing engine 210 is further configured to receive, from the optical device 122, the captured optical image of the item 106 stored in the device 100. The processing engine 210 is further configured to determine the state of the item 106 stored in the device 100 based on analysis of the captured optical images of the items 106 stored in the device 100.

In some embodiments, if the quantity of the item 106 in the device 100 is decreasing to below a threshold value, the system 300 may detect that the quantity of the item is decreased, based on information received from the first sensor 110 (i.e., the weight sensor).

In some embodiments, the state may include a health of the item 106. In case the item has begun to spoil, the system 300 may detect that the item 106 has begun to spoil based on information received from the second sensor 120 (i.e., the smell sensors), or from the image received from the optical device 122.

The processing engine 210 is configured to receive a mode of operation. In some embodiments, the mode of operation may include a shopping mode and a recipe mode. For example, the shopping mode and the recipe mode may relate to cooking items or groceries that are the items stored in the devices 100. The processing engine 210 is further configured to extract, from the central database 250, weights and states of the items 106 stored in the device 100. The processing engine 210 is further configured to determine one or more parameters relating to the weights and states of the one or more items 106 stored in the corresponding containers 104 of the one or more devices 100 based on the received mode of operation. The processing engine 210 is further configured to generate a notification relating to the determined one or more parameters.

In some embodiments, in shopping mode, the computing device 200 is further configured to determine a first parameter relating to the weights of the items 106 stored in the corresponding containers 104 of the one or more smart storage devices 100. In some embodiments, the computing device 200 is further configured to determine a second parameter relating to the states of the items 106 stored in the corresponding containers 104 of the one or more smart storage devices 100. When at least one of the weights of one or more items 106 is less than a predefined threshold, and the states of one or more items 106 lies outside a normal range, the computing device 200 is configured to generate a notification indicating that the one or more items 106 are to be replenished. Further, the computing device 200 is configured to transmit the generated notification via the transceiver unit 112 to the central database 250.

In some embodiments, the computing device 200 is further configured to receive a recipe. The recipe may be received from the user, or from an existing database. For example, the recipe may be downloaded from an existing website or application. The computing device 200 is further configured to determine, based on the recipe, a list of items required, and a quantity of the items required for the recipe. When the weights of one or more items 106 is less than the determined quantity of the corresponding items required for the recipe, the computing device 200 is configured to generate a notification indicating that the one or more items 106 are to be replenished. The computing device 200 is configured to transmit the generated notification via the transceiver unit 112 to the central database 250.

In some embodiments, in recipe mode, the computing device 200 is configured to receive a recipe. The recipe may be received from the user, or from an existing database. For example, the recipe may be downloaded from an existing website or application. The computing device 200 is configured to determine a chronology of items 106 to be used, based on the recipe. The computing device 200 is configured to generate a notification indicating a chronology of access of the smart storage devices 100 based on the determined chronology of items 106 to be used. Further, the computing device 200 is configured to transmit the generated notification via the transceiver unit 112 to the central database 250.

In some embodiments, the system 300 may further include a voice enabled device 152. The voice enabled device 152 may be configured to provide vocal cues relating to the notifications generated. In some embodiments, the notifications may be in any of the plurality of languages.

In an example, the voice enabled device 152 may recite the recipe, allowing a user to listen to commands as they prepare the recipe. The voice enabled device 152 may further indicate an instant at which the device 100 needs to be accessed by the user in order to use the item stored in the device 100. The voice enabled device 152 may further also issue or emit a sound to indicate the instant of access. In some cases, when a plurality of such devices are present, with each device storing different items, the voice enabled device 152 of any one device may emit the sound to indicate its position or location.

In some embodiments, the device 100 may include a visual indication device 130. The visual indication device 130 may include lights, such as LED lights configured to blink. The visual indication device 130 may further indicate the instant of access of the device as well as the location of the device to be accessed in order for the item store in the device 100 to be used.

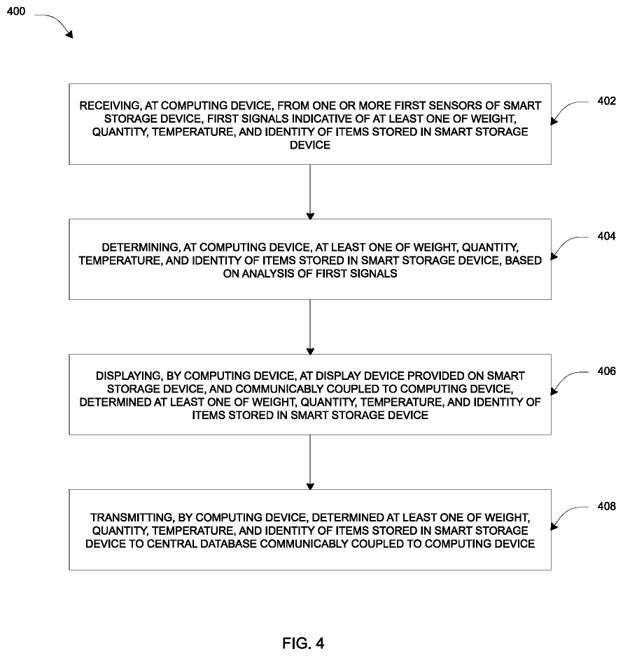

FIG. 4 illustrates a flow chart of a method 400 for storage and management of items. At step 402, the method 400 includes receiving, at the computing device, from one or more first sensors of a smart storage device, first signals indicative of at least one of the weight, quantity, temperature, and identity of the items stored in the smart storage device. At step 404, the method 400 further includes determining, at the computing device, the at least one of the weight, the quantity, the temperature, and the identity of the items stored in the smart storage device, based on analysis of the first signals. At step 406, the method 400 further includes displaying, by the computing device, at a display device provided on the smart storage device, and communicably coupled to the computing device, the determined at least one of weight, quantity, temperature, and identity of the items stored in the smart storage device. The display device is configured to display the determined at least one of weight, quantity, temperature, and identity of the items stored in the smart storage device in any one or more languages as selected by a user of the smart storage device. At step 408, the method 400 further includes transmitting, by the computing device, the determined at least one of weight, quantity, temperature, and identity of the items stored in the smart storage device to a central database communicably coupled to the computing device.

In some examples, the device 100 may be used in commercial establishments for storage and dispensation of other consumable items such as tissue paper, soap, sanitizers, etc. As the items are being dispensed, the device 100 may monitor the quantity remaining, and may notify the establishment when it is time to replenish a stock of the consumable items.

In some other examples, the device 100 may also be used in commercial establishments to monitor use of items, such as chargeable items, such as food and beverages. The device 100, through use of its sensors may determine a number or quantity of food and beverage stored in the device 100. When consumed, the device 100 may register a number or quantity of the items remaining in the device 100, and may further determine a charge associated with the items consumed.

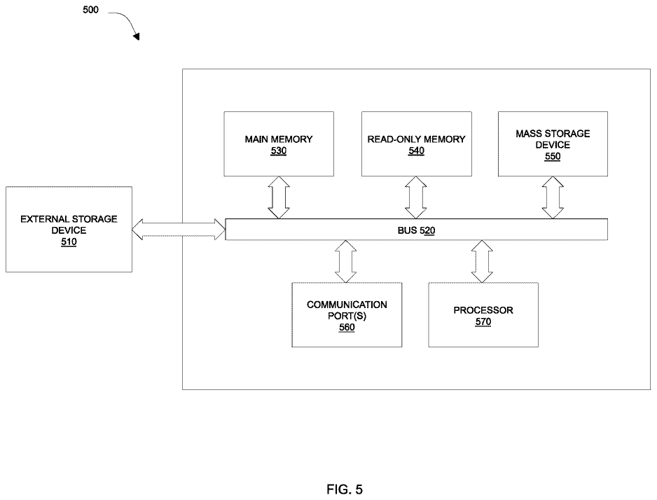

FIG. 5 illustrates an exemplary schematic block diagram of a hardware platform for implementation of the system 300. As shown in FIG. 5, a computer system 500 can include an external storage device 510, a bus 520, a main memory 530, a read only memory 540, a mass storage device 550, communication port 560, and a processor 570. A person skilled in the art will appreciate that the computer system may include more than one processor and communication ports. Examples of processor 570 include, but are not limited to, an Intel® Itanium® or Itanium 2 processor(s), or AMD® Opteron® or Athlon MP® processor(s), Motorola® lines of processors, FortiSOC™ system on chip processors or other future processors. Processor 570 may include various modules associated with embodiments of the present invention. Communication port 560 can be any of an RS-232 port for use with a modem-based dialup connection, a 10/100 Ethernet port, a Gigabit or 10 Gigabit port using copper or fibre, a serial port, a parallel port, or other existing or future ports. Communication port 560 may be chosen depending on a network, such a Local Area Network (LAN), Wide Area Network (WAN), or any network to which computer system connects. Memory 530 can be Random Access Memory (RAM), or any other dynamic storage device commonly known in the art. Read-only memory 540 can be any static storage device(s) e.g., but not limited to, a Programmable Read Only Memory (PROM) chips for storing static information e.g., start-up or BIOS instructions for processor 570. Mass storage 550 may be any current or future mass storage solution, which can be used to store information and/or instructions. Exemplary mass storage solutions include, but are not limited to, Parallel Advanced Technology Attachment (PATA) or Serial Advanced Technology Attachment (SATA) hard disk drives or solid-state drives (internal or external, e.g., having Universal Serial Bus (USB) and/or Firewire interfaces), e.g. those available from Seagate (e.g., the Seagate Barracuda 7102 family) or Hitachi (e.g., the Hitachi Deskstar 7K1000), one or more optical discs, Redundant Array of Independent Disks (RAID) storage, e.g. an array of disks (e.g., SATA arrays), available from various vendors including Dot Hill Systems Corp., LaCie, Nexsan Technologies, Inc. and Enhance Technology, Inc.

Bus 520 communicatively couples processor(s) 570 with the other memory, storage, and communication blocks. Bus 520 can be, e.g., a Peripheral Component Interconnect (PCI)/PCI Extended (PCI-X) bus, Small Computer System Interface (SCSI), USB or the like, for connecting expansion cards, drives and other subsystems as well as other buses, such a front side bus (FSB), which connects processor 570 to software system.

Optionally, operator and administrative interfaces, e.g., a display, keyboard, and a cursor control device, may also be coupled to bus 520 to support direct operator interaction with a computer system. Other operator and administrative interfaces can be provided through network connections connected through communication port 560. The external storage device 510 can be any kind of external hard-drives, floppy drives, IOMEGA® Zip Drives, Compact Disc-Read Only Memory (CD-ROM), Compact Disc-Re-Writable (CD-RW), Digital Video Disk-Read Only Memory (DVD-ROM). Components described above are meant only to exemplify various possibilities. In no way should the aforementioned exemplary computer system limit the scope of the present disclosure.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprise” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refer to at least one of something selected from the group consisting of A, B, C . . . and N, the text should be interpreted as requiring only one element from the group, not A plus N, or B plus N, etc. The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

While the foregoing describes various embodiments of the invention, other and further embodiments of the invention may be devised without departing from the basic scope thereof. The scope of the invention is determined by the claims that follow. The invention is not limited to the described embodiments, versions, or examples, which are included to enable a person having ordinary skill in the art to make and use the invention when combined with information and knowledge available to the person having ordinary skill in the art.

### Advantages of the Invention

The present invention provides a smart storage device and a method to monitor an item stored therein.

The present invention provides a smart storage device that can generate an alert when the item stored therein begins to spoil.

The present invention provides a smart storage device that can generate an alert when the item stored therein is to be replenished.

The present invention provides a smart storage device with an easily readable label.

We claim:

1. A system (300) for storage and management of items, the system (300) comprising:
a smart storage device (100) comprising:
a base (102) comprising one or more first sensors (110) to measure at least one of a weight, a quantity, a temperature, and an identity of items (106) stored in the smart storage device (100); and
a storage compartment (104) to store the items (106); and
a computing device (200) communicably coupled to the smart storage device (100), the computing device (200) comprising a processor (202) communicably coupled to a memory (204), the memory (204) storing instructions, which when executed by the processor (202) causes the computing device (200) to:
receive, from the one or more first sensors (110), first signals indicative of at least one of the weight, quantity, temperature, and identity of the items (106) stored in the smart storage device (100);
determine the at least one of the weight, the quantity, the temperature, and the identity of the items (106) stored in the smart storage device (100), based on analysis of the first signals; and
display the determined at least one of weight, quantity, temperature, and identity of the items (106) stored in the smart storage device (100) on a display device (116) provided on the smart storage device (100), and communicably coupled to the computing device (200),
wherein the display device (116) displays the determined at least one of weight, quantity, temperature, and identity of the items (106) stored in the smart storage device (100) in any one or more languages as selected by a user of the smart storage device (100), and
wherein the computing device (200) transmits the determined at least one of weight, quantity, temperature, and identity of the items (106) stored in the smart storage device (100) to a central database (250) communicably coupled to the computing device (200).

2. The system (300) as claimed in claim 1, wherein the smart storage device (100) further comprises:
a lid (108) removably coupled to the storage compartment (104), and selectively allow access to the storage compartment (104), the lid (108) comprising one or more second sensors (120) communicably coupled to the computing device (200), and measure at least a state of the items (106) stored in the smart storage device (100), and wherein the computing device (200) further:
receive, from the one or more second sensors (120), second signals indicative of at least the state of the items (106) stored in the smart storage device (100);
determine the at least the state of the items (106) stored in the smart storage device (100) based on analysis of the second signals;
display the determined at least state of the items (106) stored in the smart storage device (100) on the display device (116); and
transmit the determined at least state of the items (106) stored in the smart storage device (100) to the central database (250).

3. The system (300) as claimed in claim 2, wherein the lid (108) further comprises an optical device (122) communicably coupled to the computing device (200) and capture an optical image of the item (106) stored in the smart storage device (100), wherein the computing device (200) further:
receive, from the optical device (122), the captured optical image of the items (106) stored in the smart storage device (100); and
determine the state of the item (106) stored in the container (104) of the smart storage device (100) further based on analysis of the captured optical image of the items (106) stored in the smart storage device (100).

4. The system (300) as claimed in claim 2, wherein the lid (108) further comprises a valve (124) to allow evacuation of air from within the storage compartment (104) of the smart storage device (100).

5. The system (200) as claimed in claim 2, wherein the one or more first sensors (110) comprise at least one of a weight sensor, a temperature sensor, an RFID sensor, a QR code reader, and a barcode reader, and wherein the one or more second sensors (120) comprise at least one of a smell sensor, and an optical sensor.

6. The system (300) as claimed in claim 1, wherein the smart storage device (100) further comprises a power source (118) to supply power to components of the smart storage device (100).

7. The system (300) as claimed in claim 1, wherein the computing device (200) further:
receive a mode of operation;
extract, from the central database (250), at least one of the identity, weight, quantity, temperature, and state of the items (106) stored the smart storage device (100);
determine one or more parameters relating to at least one of the identity, weight, quantity, temperature, and state of the items (106) stored in the smart storage device (100) based on the received mode of operation;
generate a notification relating to the determined one or more parameters; and
transmit the generated notification to the central database (250).

8. The system (300) as claimed in claim 7, wherein the mode of operation comprises a shopping mode, and a recipe mode.

9. The system (300) as claimed in claim 8, wherein, in shopping mode, the computing device (200) further:
determine a first parameter relating to the weight of the items (106) stored in the smart storage device (100); and
determine a second parameter relating to the state of the items (106) stored in the smart storage device (100),
wherein, when at least one of the weight of the items (106) is less than a predefined threshold, and the state of the items (106) lies outside a normal range, the computing device (200) generate a notification indicating that the items (106) are to be replenished, and wherein the computing device (200) transmit the generated notification to the central database (250).

10. The system (300) as claimed in claim 9, wherein, the computing device (200) further:
receive a recipe;
determine, based on the recipe, at least one of a required weight and a required quantity of the items required for the recipe,
wherein, when at least one of the weight and quantity of the items (106) is less than the corresponding determined required weight and the required quantity of the items, the computing device (200) generate a notification indicating that the items (106) are to be replenished, and
wherein the computing device (200) transmit the generated notification to the central database (250).

11. The system (300) as claimed in claim 8, wherein, in recipe mode, the computing device (200) further:
receive a recipe;
determine a chronology for the items (106) to be used, based on the recipe;
wherein, the computing device (200) generates a notification indicating an instant of access of the smart storage device (100) based on the determined chronology for the items (106) to be used, and
wherein the computing device (200) transmit the generated notification to the central database (220).

12. The system (300) as claimed in claim 11, wherein the system (300) comprises a voice-enabled device, and wherein the voice-enabled device presents the notification indicating an instant of access of the smart storage device (100) in any one or more languages as selected by a user of the smart storage device (100).

13. The system (300) as claimed in claim 12, wherein the voice enabled device (152) emit a sound to indicate the instant of access of the smart storage device (100).

14. The system (300) as claimed in claim 8, wherein the system (300) comprises a microphone communicably coupled to the computing device (200), wherein the computing device (200) receive the mode of operation as a vocal command.

15. A method (400) for storage and management of items, the method (400) comprising:
receiving (402), at a computing device (200), from one or more first sensors (110) of a smart storage device (100), first signals indicative of at least one of the weight, quantity, temperature, and identity of the items (106) stored in the smart storage device (100), wherein the smart storage device (100) comprises:
a base (102) comprising the one or more first sensors (110) to measure at least one of a weight, a quantity, a temperature, and an identity of items (106) stored in the smart storage device (100); and
a storage compartment (104) to store the items (106);
determining (404), at the computing device (200), the at least one of the weight, the quantity, the temperature, and the identity of the items (106) stored in the smart storage device (100), based on analysis of the first signals;
displaying (406), by the computing device (200), at a display device (116) provided on the smart storage device (100), and communicably coupled to the computing device (200), the determined at least one of weight, quantity, temperature, and identity of the items (106) stored in the smart storage device (100),
wherein the display device (116) displays the determined at least one of weight, quantity, temperature, and identity of the items (106) stored in the smart storage device (100) in any one or more languages as selected by a user of the smart storage device (100); and
transmitting (408), by the computing device (200), the determined at least one of weight, quantity, temperature, and identity of the items (106) stored in the smart storage device

(100) to a central database (250) communicably coupled to the computing device (200).

16. A smart storage device (100) for storage and management of items, the smart storage device (100) comprising:
a base (102) comprising one or more first sensors (110) to measure at least one of a weight, a quantity, a temperature, and an identity of items (106) stored in the smart storage device (100); and
a storage compartment (104) to store the items (106); and
a computing device (200) comprising a processor (202) communicably coupled to a memory (204), the memory (204) storing instructions, which when executed by the processor (202) causes the computing device (200) to:
receive, from the one or more first sensors (110), first signals indicative of at least one of the weight, quantity, temperature, and identity of the items (106) stored in the smart storage device (100);
determine the at least one of the weight, the quantity, the temperature, and the identity of the items (106) stored in the smart storage device (100), based on analysis of the first signals; and
display the determined at least one of weight, quantity, temperature, and identity of the items (106) stored in the smart storage device (100) on a display device (116) provided on the smart storage device (100), and communicably coupled to the computing device (200),
wherein the display device (116) displays the determined at least one of weight, quantity, temperature, and identity of the items (106) stored in the smart storage device (100) in any one or more languages as selected by a user of the smart storage device (100), and
wherein the computing device (200) transmits the determined at least one of weight, quantity, temperature, and identity of the items (106) stored in the smart storage device (100) to a central database (250) communicably coupled to the computing device (200).
